(19) United States
(12) Patent Application Publication
(10) Pub. No.: US 2015/0154083 A1
(43) Pub. Date: Jun. 4, 2015

(54) INFORMATION PROCESSING DEVICE AND RECOVERY MANAGEMENT METHOD

(71) Applicant: FUJITSU LIMITED, Kawasaki-shi (JP)

(72) Inventor: Ikuroh FUJIWARA, Paderborn (DE)

(73) Assignee: FUJITSU LIMITED, Kawasaki-shi (JP)

(21) Appl. No.: 14/549,998

(22) Filed: Nov. 21, 2014

(30) Foreign Application Priority Data
Dec. 2, 2013 (JP) 2013-249632

(51) Int. Cl. G06F 11/14; G06F 11/30; G06F 11/34; H04L 12/24

(52) U.S. Cl. CPC G06F 11/1464; H04L 41/0672; G06F 11/3006; G06F 11/3404

(57) ABSTRACT

An information processing device includes: a detector configured to, when a second processing function unit monitored over a second management network is recovered by using a first processing function unit that performs a function as an information processing device and that is monitored over a first management network, detect a conflict between first network information used by the second processing function unit in the second management network and second network information used by each processing function unit monitored over the first management network; and a recovery execution unit configured to resolve the conflict between the first network information and the second network information detected by the detector so as to recover the second processing function unit by using the first processing function unit.

### CROSS-REFERENCE TO RELATED APPLICATION

This application is based upon and claims the benefit of priority of the prior Japanese Patent Application No. 2013-249632 filed on Dec. 2, 2013, the entire contents of which are incorporated herein by reference.

### FIELD

The embodiments discussed herein are related to an information processing device and a recovery management method.

### BACKGROUND

There have been techniques in which, in the event of a server failure, a server environment is taken over from an operation server to a stand-by server using network booting for automatic recovery. For example, network equipment connecting drivers in a server and connecting servers after detection of a failure performs a takeover process. Note that the server environment includes Internet protocol (IP) addresses, media access control (MAC) addresses, world wide names (WWNs), and so forth.

Additionally, even when resources in a server are divided and used using partition functions and so forth, network booting is used to automatically recover operation partitions by using stand-by partitions.

An example in which, assuming that a server A includes a partition A1 and a partition A2, and a server B includes a partition B1 and a partition B2, servers monitor their respective partitions using a management network different from a business network. If the partition A1 becomes faulty in such a situation, a management device causes another partition to take over the server environment of the partition A1, so that the partition A1 is recovered by using another partition.

Examples of the related art are Japanese Laid-open Patent Publication No. 2008-172678, Japanese Laid-open Patent Publication No. 2011-18254, Japanese Laid-open Patent Publication No. 09-321789, and Japanese Laid-open Patent Publication No. 2008-28456.

However, with the aforementioned techniques, there are some cases where recovery using network booting results in a failure, leading to discontinuity of services.

In particular, it is assumed that a faulty partition is recovered by using a partition managed over a management network that is different from the management network of the faulty partition. At this point, there are some cases where management addresses conflict in a partition serving as the recovery destination. This inhibits the server environment from being moved, making it impossible to continue services.

In the aforementioned example, in the case where the partition A1 is recovered by using the partition B2, if the management address of the partition A1 and the management address of the partition B1, which belongs to the same management network as the partition B2 serving as the recovery destination, conflict, the recovery results in a failure.

### SUMMARY

According to an aspect of the invention, an information processing device includes: a detector configured to, when a second processing function unit monitored over a second management network is recovered by using a first processing function unit that performs a function as an information processing device and that is monitored over a first management network, detect a conflict between first network information used by the second processing function unit in the second management network and second network information used by each processing function unit monitored over the first management network; and a recovery execution unit configured to resolve the conflict between the first network information and the second network information detected by the detector so as to recover the second processing function unit by using the first processing function unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of an overall configuration of a system according to a first embodiment;

FIG. 2 is a functional block diagram illustrating a functional configuration of a business server according to the first embodiment;

FIG. 3 lists an example of information stored in a server environment information table;

FIG. 4 is a table for explaining detection of a conflict between server environment information;

FIG. 5 is a table for explaining an example of an update of a server environment information table;

FIG. 6 is a flowchart illustrating the flow of a process performed by a system according to the first embodiment;

FIG. 7 is a functional block diagram illustrating a functional configuration of a business server according to a second embodiment;

FIG. 8 lists an example of information stored in an intra-/extra-housing information table;

FIG. 9 lists an example of information stored in a BIND IP-MAC table;

FIG. 10 lists an example of information stored in a network information table;

FIG. 11 is a diagram for explaining an example of determining whether it is possible to apply a network change;

FIG. 12 is a diagram for explaining an example of updating of a BIND IP-MAC table;

FIG. 13 is a flowchart illustrating the flow of a process performed by a system according to the second embodiment; and

FIG. 14 is a block diagram for explaining an example of a hardware configuration of a business server.

### DESCRIPTION OF EMBODIMENTS

Hereinafter, embodiments of an information processing device and a recovery management method disclosed herein will be described in detail with reference to the accompanying drawings. Note that the present disclosure is not limited to the embodiments. Note that the embodiments may be appropriately combined by reference to the extent the combination is not inconsistent with this disclosure.

### First Embodiment

### Overall Configuration Diagram

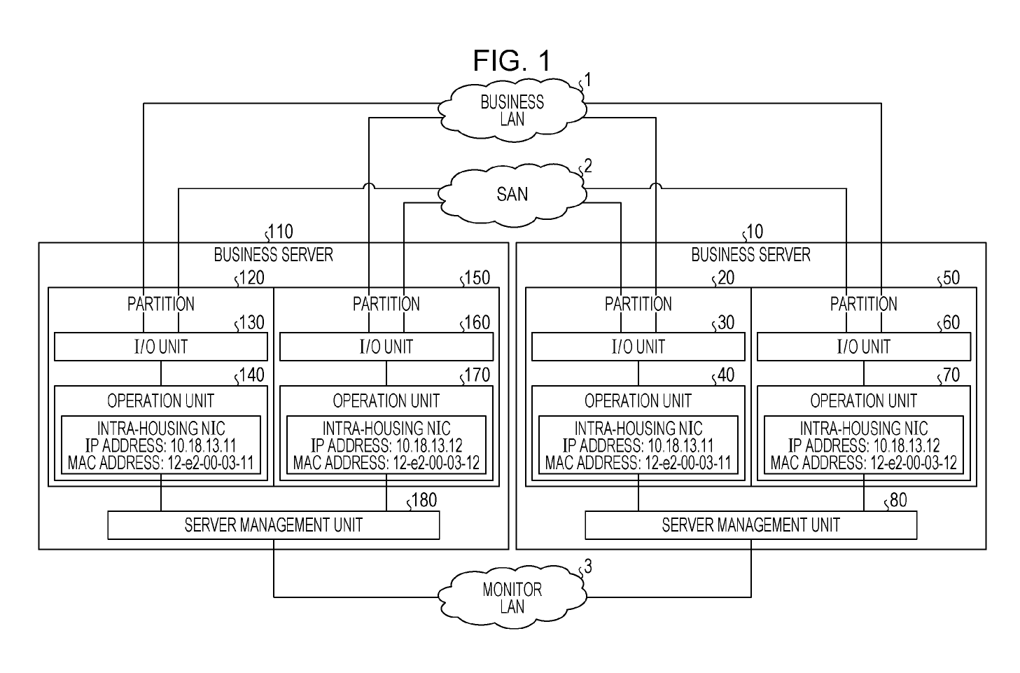

FIG. 1 is a block diagram illustrating an example of an overall configuration of a system according to a first embodiment. As illustrated in FIG. 1, the system includes a business server 10 and a business server 110.

The business server 10 includes a partition 20, a partition 50, and a server management unit 80. Note that each partition and the server management unit 80 may be logical servers within the business server 10, or may be physical servers such as blade servers.

The partition 20 includes an input/output (I/O) unit 30, which performs input and output, and an operation unit 40, which performs various types of processing, and provides services by using these components. Similarly, the partition 50 includes an I/O unit 60, which performs input and output, and an operation unit 70, which performs various types of processing, and provides services by using these components. The server management unit 80 performs monitoring and recovery using network booting of partitions within the business server 10.

The business server 110 includes a partition 120, a partition 150, and a server management unit 180. Note that each partition and the server management unit 180 may be logical servers within the business server 110, or may be physical servers such as blade servers.

The partition 120 includes an I/O unit 130, which performs input and output, and an operation unit 140, which performs various types of processing, and provides services by using these components. Similarly, the partition 150 includes an I/O unit 160, which performs input and output, and an operation unit 170, which performs various types of processing, and provides services by using these components. The server management unit 180 performs monitoring and recovery using network booting of partitions within the business server 110.

Additionally, the server management unit 80 and the server management unit 180 are connected over a monitor local area network (LAN) 3, and share information on a monitor status and each partition.

Additionally, the I/O unit of each partition includes a network interface card (NIC) and a fiber channel (FC) card. The NIC of each partition, in which an IP address and a MAC address for business services are set, is connected to the business LAN 1. The FC card of each partition, in which a WWN is set, is connected to a storage area network (SAN) 2.

Additionally, the operation of each partition includes an intra-housing NIC used for monitoring that partition. Intra-housing NICs, in each of which an IP address and a MAC address for management are set, are connected to a server management unit in the same server. Note that the MAC address set here is a virtual MAC address obtained by converting a MAC address set by a manufacturer to a virtual address to which the operating system refers.

In this embodiment, “10.18.13.11” is set as the IP address, and “12-e2-00-03-11” is set as the virtual MAC address, in the intra-housing NIC of the operation unit 40 of the partition 20. Additionally, “10.18.13.12” is set as the IP address, and “12-e2-00-03-12” is set as the virtual MAC address, in the intra-housing NIC of the operation unit 70 of the partition 50. Similarly, “10.18.13.11” is set as the IP address, and “12-e2-00-03-11” is set as the virtual MAC address, in the intra-housing NIC of the operation unit 140 of the partition 120. Additionally, “10.18.13.12” is set as the IP address, and “12-e2-00-03-12” is set as the virtual MAC address, in the intra-housing NIC of the operation unit 170 of the partition 150. Note that numbers and so forth given here are illustrative, and may be arbitrarily changed.

Here, in the first embodiment, it is assumed that the partition 120 and the partition 150 of the business server 110, and the partition 20 of the business server 10 operate, and the partition 50 of the business server 10 is stopped. Then, the partition 50 of the business server 10 is set as a stand-by system of the partition 120 of the business server 110. That is, similar applications and so forth are installed in the partition 120 of the business application 110 and the partition 50 of the business server 10.

An example in which, in this situation, the partition 120 of the business server 110 becomes faulty, and the partition 120 of the business server 110 is recovered using network booting by using the partition 50 of the business server 10 is assumed.

### [Functional Configuration of Business Server]

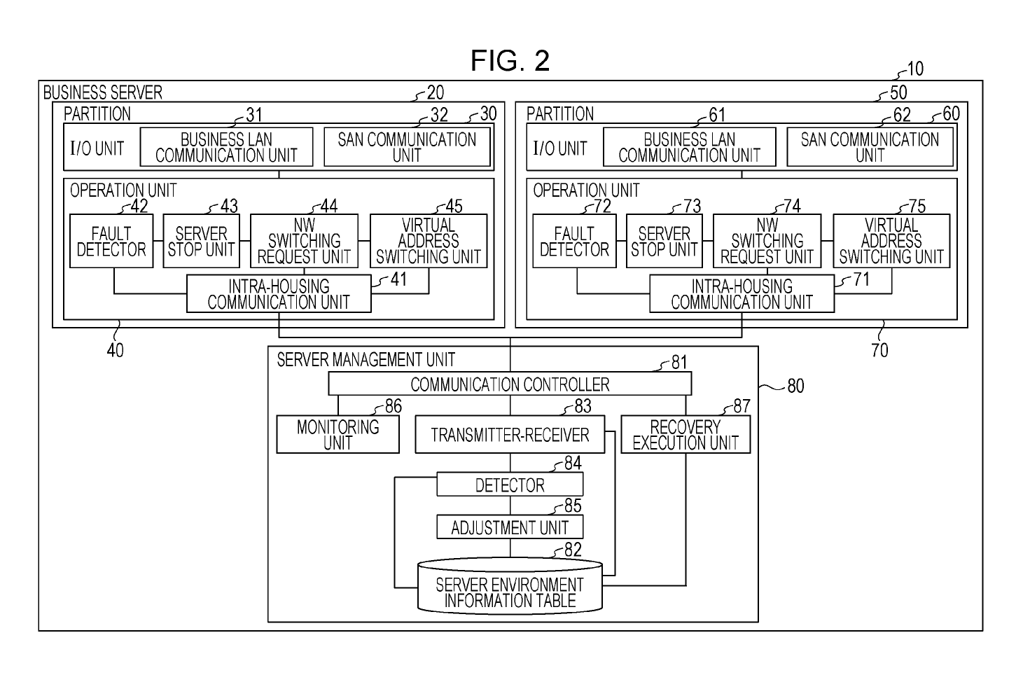

FIG. 2 is a functional block diagram illustrating a functional configuration of a business server according to the first embodiment. The business server 10 and the business server 110 have similar configurations, and therefore the business server 10 will be described here.

As illustrated in FIG. 2, the business server 10 includes the partition 20, the partition 50, and the server management unit 80. Note that the partition 20 and the partition 50 have similar configurations, and therefore the partition 50 will be described here.

### (Functional Configuration of Partition)

The partition 50 includes the I/O unit 60 and the operation unit 70, as illustrated in FIG. 2. The I/O unit 60 includes a business LAN communication unit 61 and a SAN communication unit 62, through which transmission and reception of information on business services, for example, are performed.

The business LAN communication unit 61 is a processing unit that performs communication with other devices connected to the business LAN 1, and is, for example, an NIC. For example, the business LAN communication unit 61 performs transmission and reception of packets for business services.

The SAN communication unit 62 is a processing unit that performs communication with storage devices connected to a SAN 2, and is, for example, an FC card. For example, the SAN communication unit 62 performs data writing to a storage device and data reading from a storage device.

The operation unit 70 is a processing unit that handles processing of the entire partition 50, and is a processing unit having, for example, a processor or a virtual processor, a memory, and so forth. The operation unit 70 includes an intra-housing communication unit 71, a fault detector 72, a server stop unit 73, an NW switching request unit 74, and a virtual address switching unit 75. Note that the fault detector 72, the server stop unit 73, the NW change request unit 74, and the virtual address switching unit 75 are, for example, processes or the like performed by processors and so forth.

The intra-housing communication unit 71, in which an IP address and a MAC address for management use are set, performs transmission and reception of information on monitoring of the partition 50. In particular, the intra-housing communication unit 71, which is connected to the server management unit 80, receives an instruction for performing recovery, a server environment, and so forth. Additionally, the intra-housing communication unit 71 sends a notification of a fault of the partition 50, an instruction for recovery, and so forth to the server management unit 80.

The fault detector 72 is a processing unit that detects a fault of the partition 50. For example, the fault detector 72 performs monitoring of life and death of the partition 50 and monitoring of an application performed in the partition 50. Then, if the fault detector 72 detects a fault, the fault detector 72 notifies the server stop unit 73 of detection of the fault, and notifies the server management unit 80 of the fault content and so forth over the intra-housing communication unit 71.

The server stop unit 73 is a processing unit that stops a partition where a fault has been detected. In particular, in the case where a fault has occurred in an application, the server stop unit 73 stops that application, and in the case where the function as a business server of the partition 50 becomes faulty, the server stop unit 73 stops that function. At this point, the server stop unit 73 inhibits processing units and so forth connected to the monitor LAN 3 from stopping. Additionally, the server stop unit 73 notifies the stop of functions and so forth to the NW switching request unit 74, and also notifies it to the server management unit 80 through the intra-housing communication unit 71.

The NW switching request unit 74 is a processing unit that requests the server management unit 80 for switchover of a network when a partition is stopped because of a fault. In particular, when a fault in the partition 50 is detected, the NW switching request unit 74 requests the server management unit 80 to perform switchover to the stand-by system. That is, the NW switching request unit 74 makes a request for performing recovery using network booting.

The virtual address switching unit 75 is a processing unit that switches address information to address information of the recovered partition. In particular, having received a switching instruction from the server management unit 80, the virtual address switching unit 75 switches the management address of a partition serving as the recovery destination to the management address of a partition serving as the recovery source.

For example, the virtual address switching unit 75 acquires an IP address and a virtual MAC address for management use used by the partition 20 serving as the recovery source from the server management unit 80, and sets the acquired addresses in the intra-housing communication unit 71. Additionally, the virtual address switching unit 75 acquires address information and a WWN for business use used by the partition 20 serving as the recovering source from the server management unit 80 and so forth, and sets them in the business LAN communication unit 61 and the SAN communication unit 62.

### (Functional Configuration of Server Management Unit)

As illustrated in FIG. 2, the server management unit 80 includes a communication controller 81, a server environment information table 82, a transmitter-receiver 83, a detector 84, an adjustment unit 85, a monitoring unit 86, and a recovery execution unit 87. Note that each processing unit is, for example, a process performed by a processor, or an electric circuit.

The communication controller 81 is a processing unit connected over the monitor LAN 3 to another server. In particular, the communication controller 81 is connected to the intra-housing communication unit of each partition included in the business server 10, and is connected to the server management unit 180 included in the business server 110.

For example, the communication controller 81 sends a recovery request to the server management unit 180, and receives a recovery request from the server management unit 180. The communication controller 81 also receives notifications of faults and so forth from partitions, and sends instructions for recovery, instructions for switching of address information, and so forth.

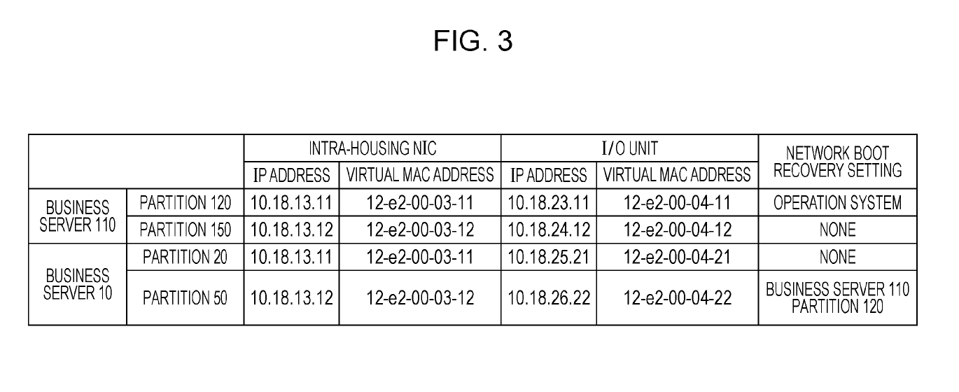

The server environment information table 82 is a table that stores information set in each business server within a system, and is stored in, for example, a memory. FIG. 3 is a table listing an example of information stored in a server environment information table. As illustrated in FIG. 3, the server environment information table 82 stores “Intra-housing NIC (IP address, Virtual MAC address), I/O unit (IP address, Virtual MAC address), Network boot recovery setting” in association with each partition of each business server. Note that the server environment information table 82 may store WWNs and so forth other than these items in association with each partition.

An IP address as “Intra-housing NIC (IP address)” stored here is an IP address for management use used in an intra-housing network, that is, a network for management use, and is an IP address set for an intra-housing communication unit of a partition. A virtual MAC address as an “Intra-housing NIC (Virtual MAC address)” is a MAC address for management use used in an intra-housing network, that is, a network for management use, and is a virtual MAC address set in an intra-housing communication unit of a partition. The operating system within a partition sends and receives information on monitoring using these IP and virtual MAC addresses.

An IP address as “I/O unit (IP address)” stored here is an IP address for management use used in an extra-housing network, that is, a network for business use, and is an IP address set for a business LAN communication unit of a partition. A virtual MAC address as “I/O unit (Virtual MAC address)” is a MAC address for business use used in an extra-housing network, that is, a network for business use, and is a virtual MAC address set for a business LAN communication unit of a partition. The operating system within a partition sends and receives information on business using these IP and virtual MAC addresses. Additionally, “Network boot recovery setting” stores information indicating an operation system and a stand-by system.

In the example of FIG. 3, the IP address “10.18.13.12” and the virtual MAC address “12-e2-00-03-12” are set in the intra-housing communication unit 71 of the partition 50 of the business server 10. Additionally, an IP address “10.18.26.22” and a virtual MAC address “12-e2-00-04-22” are set in the application LAN communication unit 61 of the partition 50 of the business server 10. Additionally, the partition 120 of the business server 110 is set to be an operation system, and the partition 50 of the business server 10 is set to be a stand-by system.

Additionally, as listed in FIG. 3, duplicate management addresses are set in different business servers, that is, business servers whose server management units manage different objects. However, such management addresses are used only for communication between a server management unit and a business server. Consequently, an error due to duplication will not occur. In contrast, business addresses are set to respective unique addresses since business servers are connected to the same business LAN 1.

The transmitter-receiver 83 is a processing unit that sends and receives a server environment between server management units. In particular, when management addresses, business addresses, and so forth are set for each partition of the business server 10, the transmitter-receiver 83 sends the set information to the server management unit 180 in the same system. The transmitter-receiver 83 also receives address information set for each partition of the business server 110 from the server management unit 180.

Then, the transmitter-receiver 83 generates the server environment information table 82 using information sent and received. At this point, the transmitter-receiver 83 receives information on an operation system and a stand-by system from an administrator or the like, and stores the information in the server environment information table 82.

The detector 84 is a processing unit that detects duplication of management addresses from a server environment after recovery. In particular, when recovering the partition 120 of the faulty business server 110 by using the partition 50 during a stop in operation, the detection unit 84 detects a conflict between management addresses that occurs after recovery in the business server 10 serving as the recovery destination.

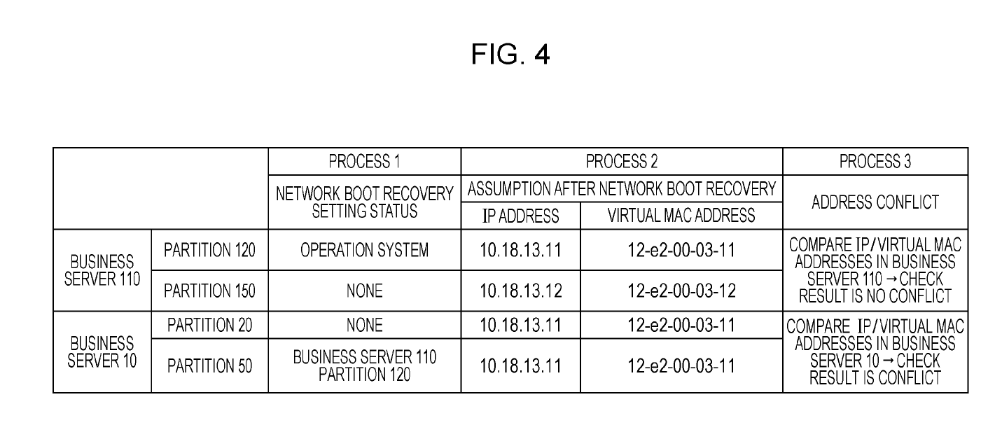

Here, a specific example of a processing procedure of conflict detection will be explained. FIG. 4 is a table for explaining detection of a conflict between server environment information. As listed in FIG. 4, first, the detection unit 84 refers to the presence or absence of network boot recovery setting set in the server environment information table 82 (process 1). Here, the detection unit 84 identifies that the stand-by system of the partition 120 of the business server 110 is the partition 50 of the business server 10.

Next, the detection unit 84 assumes setting of management addresses after network recovery (process 2). Here, the detection unit 84 assumes that the management addresses “10.18.13.11, 12-e2-00-03-11” of the partition 120 serving as the recovery source are set for the partition 50 serving as the recovery destination.

Thereafter, the detection unit 84 determines whether management addresses duplicate in the business server 10 serving as the recovery destination (process 3). In the case of FIG. 4, the detection unit 84 detects that a conflict occurs between management addresses of the partition 20 and the partition 50 assumed after recovery. Accordingly, the detection unit 84 notifies the adjustment unit 85 that the management addresses conflict. At this point, if the management addresses do not conflict, the detection unit 84 notifies the adjustment unit 85 of the absence of a conflict.

The adjustment unit 85 is a processing unit that resolves a conflict between management addresses detected by the detection unit 84. In particular, the adjustment unit 85 rewrites address information of any of partitions for which a conflict has been detected, with an address that does not result in a conflict. For example, the adjustment unit 85 rewrites a management address of a partition that is not the recovery destination, among partitions whose management addresses conflict, with another address in the server environment information table 82.

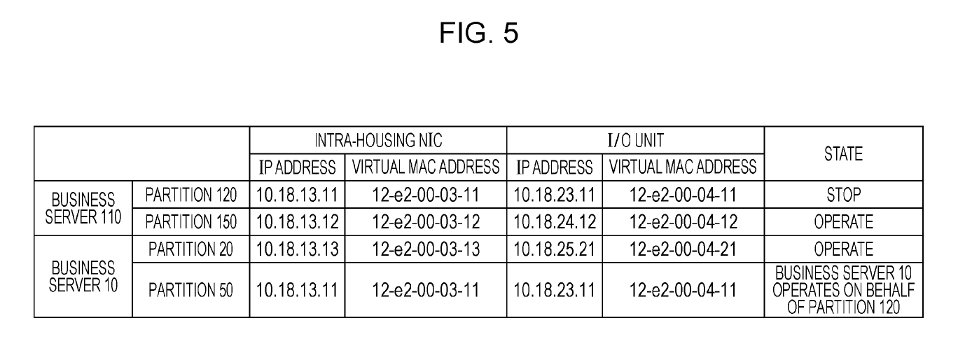

FIG. 5 is a table for explaining an example of an update of a server environment information table. As listed in FIG. 5, the adjustment unit 85 rewrites the management addresses “10.18.13.11, 12-e2-00-03-11” of the partition 20 that is not the destination of recovery, among the partition 20 and the partition 50 of the business server 10 whose management addresses conflict, with “10.18.13.13, 12-e2-00-03-13”. In this way, even if recovery actually occurs, a conflict between management addresses may be inhibited. This, in turn, inhibits a failure of recovery using network booting.

Additionally, although description has been given here of an example in which the management address of a partition that does not serve as a recovery destination, among partitions whose management addresses conflict, is rewritten with another address before occurrence of recovery; however, it is possible to resolve a conflict by other methods. For example, it is possible for the adjustment unit 85 to make a reservation that, at the time of occurrence of recovery, the management addresses “10.18.13.11, 12-e2-00-03-11” of the partition 50 serving as the recovery destination is rewritten to management addresses “10.18.13.13, 12-e2-00-03-13” for recovery. In this case, the adjustment unit 85 performs rewriting of management addresses when recovery is actually performed.

The monitoring unit 86 is a processing unit that receives a fault notification or a normal notification from each partition that is a partition to be monitored. For example, the monitoring unit 86 receives fault notifications and normal notifications from the partition 20 and the partition 50 of the business server 10, and manages the states of the partitions. Having received a fault notification of a partition, the monitoring unit 86 requests the recovery execution unit 87 to perform recovery.

The recovery execution unit 87 is a processing unit that requests the server management unit 180 to perform recovery when a fault of a partition is detected by the monitoring unit 86. The recovery execution unit 87 is also a processing unit that, upon receipt of a recovery request from the server management unit 180, performs recovery in accordance with the server environment information table 82.

For example, when the partition 20 becomes faulty, the recovery execution unit 87 sends a recovery request, together with information indicating the partition 20, to the server management unit 180 to request recovery of the partition 20. Note that if the recovery destination is specified within the business server 10 in the event of a fault of the partition 20, the recovery execution unit 87 performs recovery by using the specified partition.

Additionally, having received a recovery request, together with information indicating the partition 120 of the business server 110, from the server management unit 180, the recovery execution unit 87 identifies the partition 50 as the recovery destination with reference to the server environment information table 82. Then, the recovery execution unit 87 acquires management addresses to be set for the intra-housing communication unit 71, business addresses to be set for communication units of the I/O unit 60, WWNs, and so forth from the server environment information table 82, and notifies the partition 50 of them. Thereafter, upon receipt of a notification from the partition 50 of the fact that setting of address information and so forth has been completed, the recovery execution unit 87 starts the recovered partition 50, that is, a stand-by server.

### [Flow of Process]

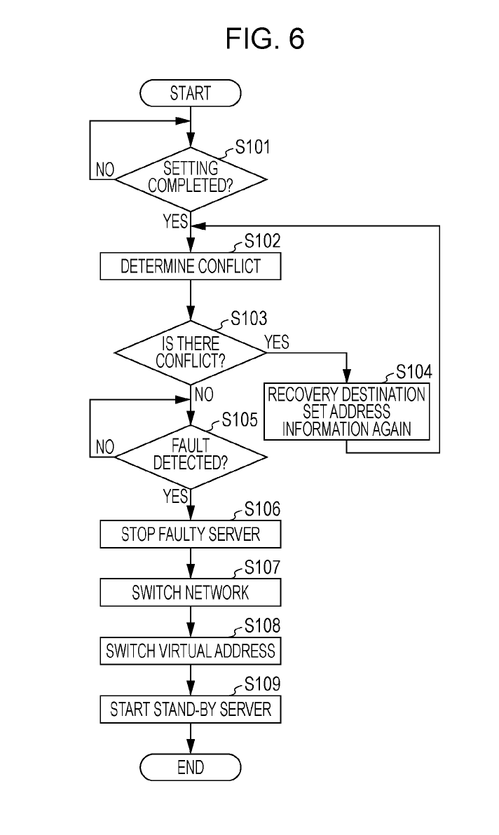

FIG. 6 is a flowchart illustrating the flow of a process performed by a system according to the first embodiment. As illustrated in FIG. 6, upon completion of setting of the server environment for each partition of each business server (S101: Yes), the server management unit 80 serving as the recovery destination performs the process of S102.

Then, server management units exchange the set server environments, and the detector 84 of the server management unit 80 serving as the recovery destination determines whether there is a conflict between management addresses (S102). Here, the server management unit 80 refers to the generated server environment information table 82 to be able to determine that the server to which the server management unit 80 belongs is on the recovery destination side.

Then, if it is determined that there is a conflict (S103: Yes), the server management unit 80 serving as the recovery destination sets an address that does not result in a conflict to rewrite the server environment information table 82 (S104), and returns to S102. If, however, it is determined that there is not a conflict (S103: No), the server management unit 80 serving as the recovery destination performs the process of S105.

Thereafter, when the server management unit 180 detects a fault of the partition 120 (S105: Yes), the partition 120 stops operation of the partition 120, that is, a business server (S106). For example, the partition 120 stops an application or the like that will function as a business server.

Subsequently, the faulty partition 120 instructs the server management unit 180 for network switchover, and the server management unit 180 switches the network to the recovery destination (S107). At this point, the server management unit 180 sends a recovery request to the server management unit 80.

Then, the recovery execution unit 87 of the server management unit 80 notifies the partition 50 serving as the recovery destination of the server environment, such as a management address to be set, in accordance with the server environment information table 82, and the virtual address switching unit 75 sets addresses and so forth (S108). Thereafter, the recovery execution unit 87 of the server management unit 80 starts the partition 50, that is, the stand-by server (S109). For example, the operation unit 70 of the partition 50 starts an application or the like that will function as a business server, in accordance with an instruction of the server management unit 80.

### [Advantages]

In this way, before occurrence of recovery, the server management unit 80 to be the recovery destination assumes a server environment after recovery, and resets management addresses in advance if duplication of management addresses would occur. This may inhibit occurrence of mismatch in advance. Accordingly, even when processing is performed as usual at the time of actual occurrence of that recovery using network booting, recovery may be completed without an error.

Additionally, preparing one stand-by system for housings in the same subnet, without preparing a stand-by system within the same business server, enables recovery using network booting to be realized. Compared to the case where recovery using network booting is performed within the same business server, the number of partitions waiting as a stand-by system is smaller.

### Second Embodiment

The example in which the recovery destination is during a stop in operation has been described in the first embodiment, the present disclosure is not limited to this. Even when the recovery destination is during operation, it is possible to complete recovery without an error.

Accordingly, in a second embodiment, an example in which recovery using network booting is performed when the recovery destination is during operation will be described. The overall configuration diagram assumed in the second embodiment is similar to that in the first embodiment. In the second embodiment, it is also assumed that the partition 120 and the partition 150 of the business server 110 and the partition 20 and the partition 50 of the business server 10 are in operation. The partition 50 of the business server 10 is set as a stand-by system of the partition 120 of the business server 110.

An example in which, in this situation, the partition 120 of the business server 110 becomes faulty, and the partition 120 of the business server 110 is recovered using network booting by using the partition 50 of the business server 10 is assumed.

[Functional Configuration of Business Server]

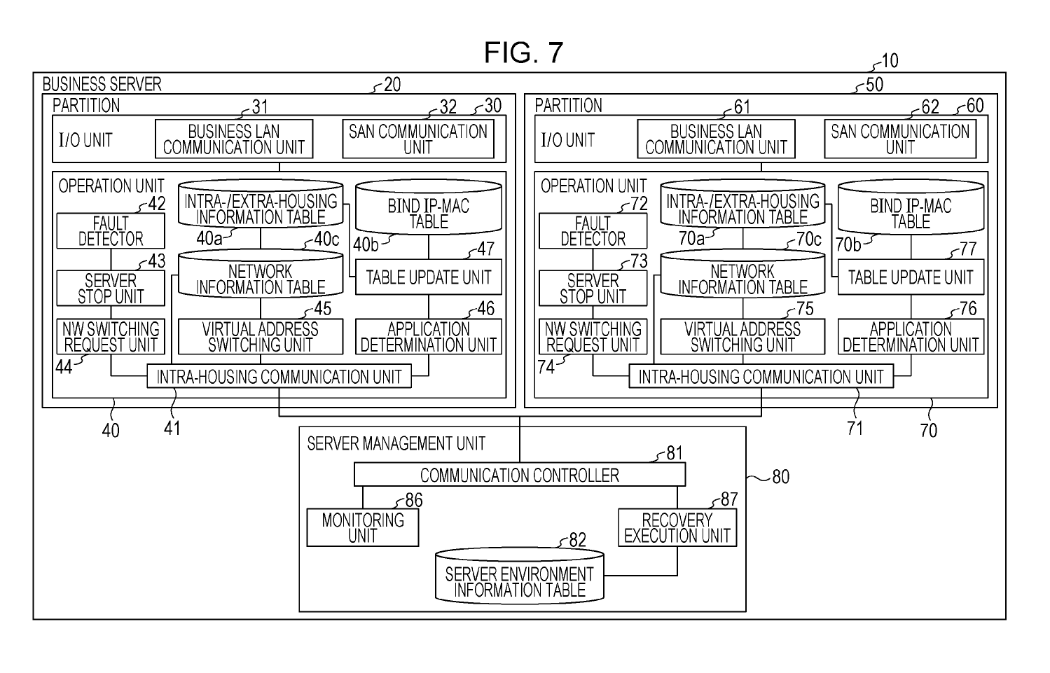

FIG. 7 is a functional block diagram illustrating a functional configuration of a business server according to the second embodiment. The business server 10 and the business server 110 have similar configurations, and therefore the business server 10 will be described here. Additionally, processing units and so forth having functions similar to those in the first embodiment are denoted by the same reference numerals as in FIG. 2, and the detailed description thereof will be omitted.

Here, the operation unit 70 of the partition 50 having functions different from those in the first embodiment will be described. Note that the intra-housing communication unit 71, the fault detector 72, and the server stop unit 73 perform functions similar to those in the first embodiment, and therefore detailed description thereof will be omitted.

The operation unit 70 includes an intra-/extra-housing information table 70a, a BIND IP-MAC table 70b, a network information table 70c, an application determination unit 76, and a table update unit 77 as functions different from those in the first embodiment.

The intra-/extra-housing information table 70a is a table that stores information indicating which of an intra-housing network and an extra-housing network devices belong to. That is, the intra-/extra-housing information table 70a stores information indicating whether each device in the partition 50 is a management-use device or a business-use device.

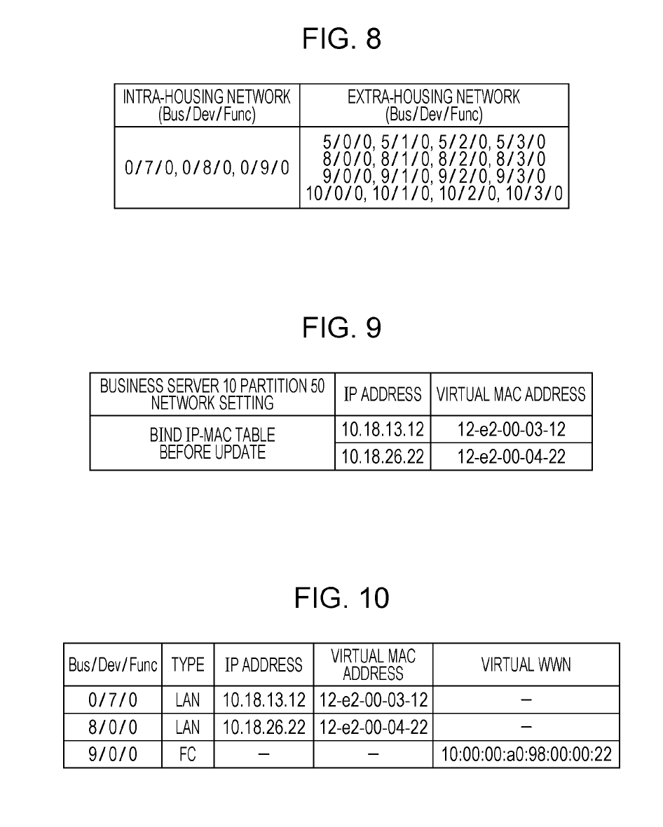

FIG. 8 lists an example of information stored in an intra-/extra-housing information table. As listed in FIG. 8, the intra-/extra-housing information table 70a stores “Intra-housing network” and “Extra-housing network”. Here, “Intra-housing network” indicates management-use devices connected to the monitor LAN 3 for management use. “Extra-housing network” indicates business-use devices connected to the business LAN 1 or the SAN 2 for business use.

In the example of FIG. 8, devices of “0/7/0”, “0/8/0”, and “0/9/0” in “Bus/Dev/Func” are management-use devices. Additionally, devices of “5/0/0”, “5/1/0”, “10/0/0”, and so forth in “Bus/Dev/Func” are business-use devices. Here, “Bus/Dev/Func” is an example of address notation for identifying a device in PCI Express. “Bus” indicates a bus number, “Dev” indicates a device number, and “Func” indicates a function number.

The BIND IP-MAC table 70b is a table that stores address information referred to by the operating system in a partition. That is, an operating system performs transmission and reception of data using the address information stored in this table.

FIG. 9 lists an example of information stored in the BIND IP-MAC table. FIG. 9 illustratively depicts a table corresponding to partitions of the business server 10, and the BIND IP-MAC table 70b stores information for each partition.

As illustrated in FIG. 9, the BIND IP-MAC table 70b stores the “IP address” and the “virtual MAC address” in association with each other as information on the partition 50 of the business server 10. The “IP address” stored here is an IP address referred to by the operating system of the partition 50, and the “virtual MAC address” is a virtual MAC address referred to by the operating system of the partition 50. Note that the BIND IP-MAC table 70b may also store WWNs besides these addresses.

In the example of FIG. 9, the operating system of the partition 50 refers to “10.18.13.12, 12-e2-00-03-12” as “the IP address and the virtual MAC address”. This is information set in the intra-housing communication unit 71 of the operation unit 70 of the partition 50, and is also address information for management use. The operating system of the partition 50 also refers to “10.18.26.22, 12-e2-00-04-22” as “the IP address and the virtual MAC address”. This is information set in the I/O unit 60 of the partition 50, and is also address information for business use.

The network information table 70c is a table that stores information on devices included in the partition 50 and networks to which the devices are connected. FIG. 10 lists an example of information stored in the network information table.

The network information table 70c stores “Bus/Dev/Func, Type, IP address, Virtual MAC address, and Virtual WWN” in association with one another. “Bus/Dev/Func” is information identifying a device, and “Type” is information indicating the type of a device. “IP address” is an IP address set for a device, and “Virtual MAC address” is a virtual MAC address recognized as the MAC address of that device by the operating system. “Virtual WNN” is a virtual WWN recognized as the WWN of that device by the operating system.

In the example of FIG. 10, the network information table 70c stores “0/7/0, LAN, 10.18.13.12, and 12-e2-00-03-12, -”, “8/0/0, LAN, 10.18.26.22, 12-e2-00-04-22, -”, and “9/0/0, FC, -, -, 10:00:00:a0:98:00:00:22”.

That is, the device “0/7/0” is a device connected to a LAN, and the IP address “10.18.13.12” and the virtual MAC address “12-e2-00-03-12” are set for this. Additionally, the device “8/0/0” is a device connected to the LAN, and the IP address “10.18.26.22” and the virtual MAC address “12-e2-00-04-22” are set for this. Additionally, the device “9/0/0” is a device connected to a SAN, and the WWN “10:00:00:a0:98:00:00:22” is set for this.

The application determination unit 76 is a processing unit that determines whether a management-address change associated with recovery is suitable. In particular, the application determination unit 76 determines whether a management-address change occurs at the time of recovery, and, if so, determines the suitability of that change. Then, if a management-address change occurs, the application determination unit 76 decides upon management addresses originally set for a partition serving as the recovery destination, not management addresses set for a faulty partition, as addresses to be used after recovery.

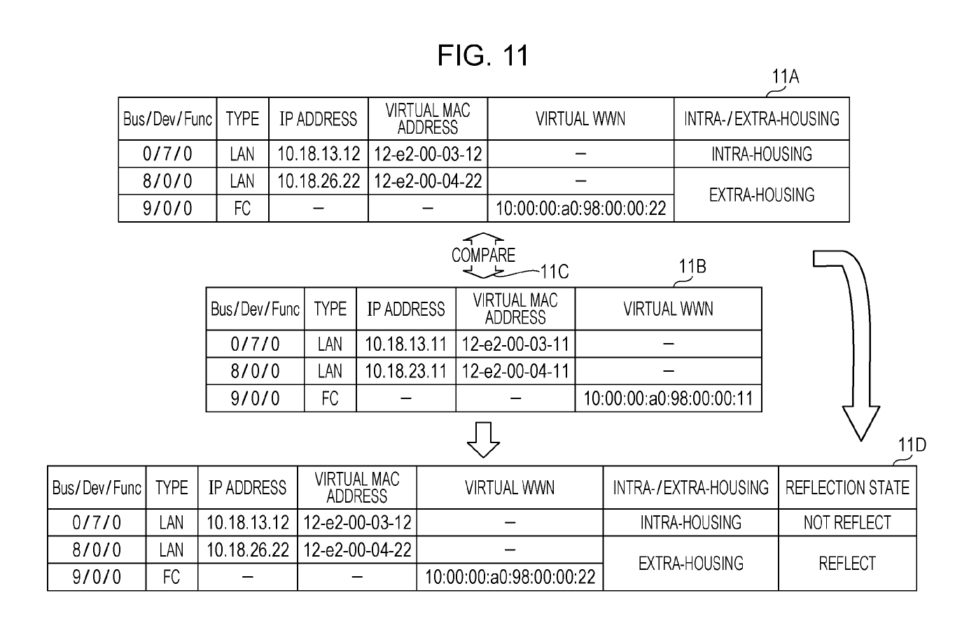

Here, for a determination as to application made by the application determination unit 76, an example of the partition 50 will be described. FIG. 11 is a diagram for explaining an example of determining whether it is possible to apply a network change. As illustrated in FIG. 11, from the network information table 70c illustrated in FIG. 10 and the intra-/extra-housing information table 70a illustrated in FIG. 8, the application determination unit 76 determines which of a management-use (intra-housing) network and a business-use (extra-housing) network each device is connected to (11A of FIG. 11).

Here, the application determination unit 76 determines that the device “0/7/0” is a device connected to a management-use intra-housing network. That is, the device “0/7/0” corresponds to the intra-housing communication unit 71. Additionally, the application determination unit 76 determines that the devices “8/0/0” and “9/0/0” are devices connected to a business-use extra-housing network. That is, the device “8/0/0” corresponds to the business LAN communication unit 61, and the device “9/0/0” corresponds to the SAN communication unit 62.

Then, the application determination unit 76 acquires network information as the target of switchover from the virtual address switching unit 75 (11B of FIG. 11). In particular, the application determination unit 76 acquires information to which “Bus/Dev/Func, Type IP address, Virtual MAC address, Virtual WWN” corresponds. Here, the application determination unit 76 acquires “0/7/0, LAN, 10.18.13.11, 12-e2-00-03-11, -”, “8/0/0, LAN, 10.18.23.11, 12-e2-00-04-11, -” and “9/0/0, FC, -, -, 10:00:00:a0:98:00:00:11”.

Thereafter, the application determination unit 76 compares the current network information of the recovery destination illustrated at 11A of FIG. 11 with the network information of the recovery source illustrated at 11B of FIG. 11 to determine whether a management-address change will occur (11C of FIG. 11). In this example, since the address of the device “0/7/0” determined as the intra-housing network illustrated at 11A of FIG. 11 and the address corresponding to the device “0/7/0” at 11B of FIG. 11 are different, the application determination unit 76 determines that a management-address change will occur.

As a result, in recovery, the application determination unit 76 determines to refuse a change in the management address used in the intra-housing network, and to permit a change in the business address used in the extra-housing network (11D of FIG. 11).

In particular, the application determination unit 76 determines that although a change in the management address in recovery is requested from the virtual address switching unit 75, the management address will be changed between before and after recovery, which incurs the risk of occurrence of a conflict. Accordingly, for the management address, the application determination unit 76 determines not to allow the management address of the partition 120, which serves as the recovery source, to be reflected. In contrast, the application determination unit 76 determines to change the business address, since operations of the partition 120, which serves as the recovery source, will be performed after recovery. Accordingly, for the business address, the application determination unit 76 determines to allow the business address of the partition 120, which serves as the recovery source, to be reflected.

Based on these results, the application determination unit 76 sends the virtual address switching unit 75 an instruction for refusing a change in the management address and permitting a change in the business address. The application determination unit 76 sends the table update unit 77 a business address to be reflected, and instructs the table update unit 77 to update the BIND IP-MAC table 70b. Here, the application determination unit 76 sends “8/0/0, LAN, 10.18.23.11, 12-e2-00-04-11, -” to the table update unit 77. Thereafter, the virtual address switching unit 75 inhibits a management address from being reset, and performs setting of a business address and a WWN.

The table update unit 77 is a processing unit that performs updating of the BIND IP-MAC table 70b in association with recovery. In particular, the table update unit 77 adds “8/0/0, LAN, 10.18.23.11, 12-e2-00-04-11, -” received from the application determination unit 76 to the BIND IP-MAC table 70b.

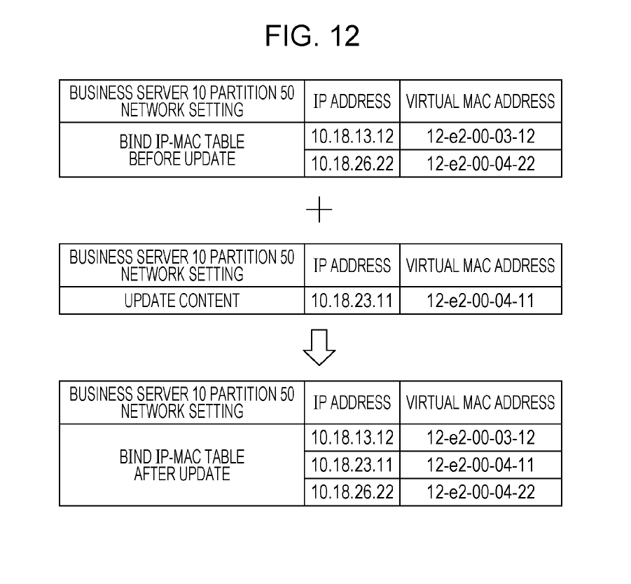

FIG. 12 is a diagram for explaining an example of updating of a BIND IP-MAC table. As illustrated in FIG. 12, the table update unit 77 receives “10.18.23.11, 12-e2-00-04-11” in a situation where “10.18.13.12, 12-e2-00-03-12” and “10.18.26.22, 12-e2-00-04-22” are stored as “IP address, Virtual MAC address”. Then, the table update unit 77 adds a new record corresponding to “10.18.23.11, 12-e2-00-04-11” to the BIND IP-MAC table 70b. As a result, the operating system of the partition 50 may recognize the business address of the recovered partition 120 with accuracy after recovery, and thus may perform communication and so forth on business without causing discontinuity of communication.

### [Flow of Process]

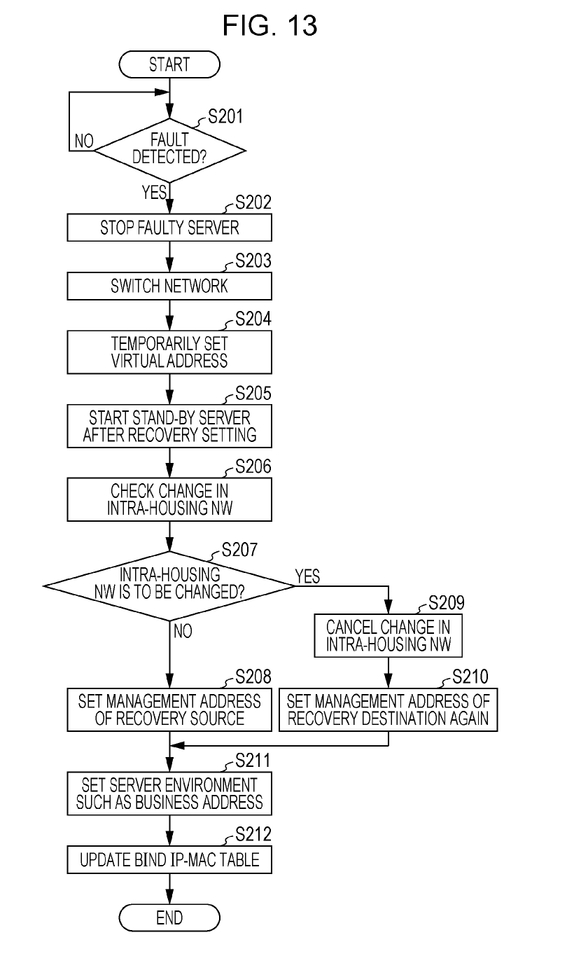

FIG. 13 is a flowchart illustrating the flow of a process performed by the system according to the second embodiment. As illustrated in FIG. 13, when the server management unit 180 detects a fault of the partition 120 (S201: Yes), the partition 120 stops the operation of the partition 120, that is, a business server (S202).

Subsequently, the faulty partition 120 instructs the server management unit 180 for network switchover, and the server management unit 180 switches the network to the recovery destination (S203). At this point, the server management unit 180 sends a recovery request to the server management unit 80.

Then, in accordance with the server environment information table 82, the recovery execution unit 87 of the server management unit 80 notifies the partition 50, which is the recovery destination, of a server environment such as management addresses to be set, and the virtual address switching unit 75 temporarily sets each address and so forth (S204). Subsequently, the recovery execution unit 87 of the server management unit 80 starts a stand-by server in which the server environment of a recovery target is set (S205). By way of example, the recovery execution unit 87 restarts a stand-by server after the server environment to be recovered is set in the stand-by server.

Thereafter, the application determination unit 76 of the partition 50 serving as the recovery destination determines whether there is a change in the intra-housing network, that is, the management addresses (S206).

Here, if it is determined that there is no change (S207: No), the application determination unit 76 permits the management addresses of the recovery source to be set just as they are (S208). That is, the virtual address switching unit 75 applies the state temporarily set in S204, and formally completes the setting.

If, however, it is determined that there is a change (S207: Yes), the application determination unit 76 cancels a change of the intra-housing network (S209). That is, the application determination unit 76 instructs the virtual address switching unit 75 to reset the temporarily set management addresses.

Then, the virtual address switching unit 75 discards the management addresses of the partition 120 serving as the recovery source that are temporarily set in S204, and resets the management addresses originally set for the partition 50, which is the recovery destination (S210).

After performing the process of S208 or S210, the virtual address switching unit 75 sets a server environment such as business addresses to be set, in the partition 50 serving as the recovery destination (S211). Then, the table update unit 77 updates the BIND IP-MAC table 70b in the set server environment in order to validate a server environment set for the partition 50 (S212).

### [Advantages]

In this way, the server management unit 80 may recover a partition serving as the recovery source with accuracy even if a partition serving as the recovery destination is during operation. Accordingly, it is possible to perform recovery by using a partition being used, without preparing a stand-by system during a stop in operation. Thus, efficient server operation may be achieved. Additionally, the partition serving as the recovery destination not only simply sets address information but also may update the BIND IP-MAC table 70b so as to allow the BIND IP-MAC table 70b to be referred to by the operating system. Therefore, discontinuity of communication due to a setting error or the like may be inhibited after completion of recovery.

### Third Embodiment

Although the embodiments of the present disclosure have been described, the present disclosure may be practiced in various forms other than the foregoing embodiments. Accordingly, a different embodiment will be described below.

### (Recovery Target)

Although, in the foregoing embodiments, the example of recovering the partition 120 by using the partition 50 has been described, the recovery target is not limited to a partition. For example, the physical server may be recovered by using a partition, and a partition may be recovered by using a physical server and may also be recovered by using a virtual machine or the like.

### (System)

Additionally, among the processes described in the embodiments, all or some of the processes described to be automatically performed may be performed manually. Alternatively, all or some of the processes described to be manually performed may be automatically performed in a known way. Besides, information including processing procedures, control procedures, specific names, various types of data, and parameters indicated in the foregoing document and drawings may be arbitrarily changed, unless otherwise specified.

Additionally, elements of devices are illustrated in the drawings in terms of functional concepts, and it is unnecessary for the elements to be physically configured as illustrated in the drawings. That is, specific forms of distribution and integration of devices are not limited to those illustrated in the drawings. That is, all or some of the devices may be configured so as to be functionally or physically distributed and integrated on an arbitrary unit in accordance with various load and usage conditions. Furthermore, regarding various processing functions performed in devices, all or some thereof may be implemented by a CPU or a program analyzed and executed on the CPU, or may be implemented as hardware using wired logic.

### (Configuration of Business Server)

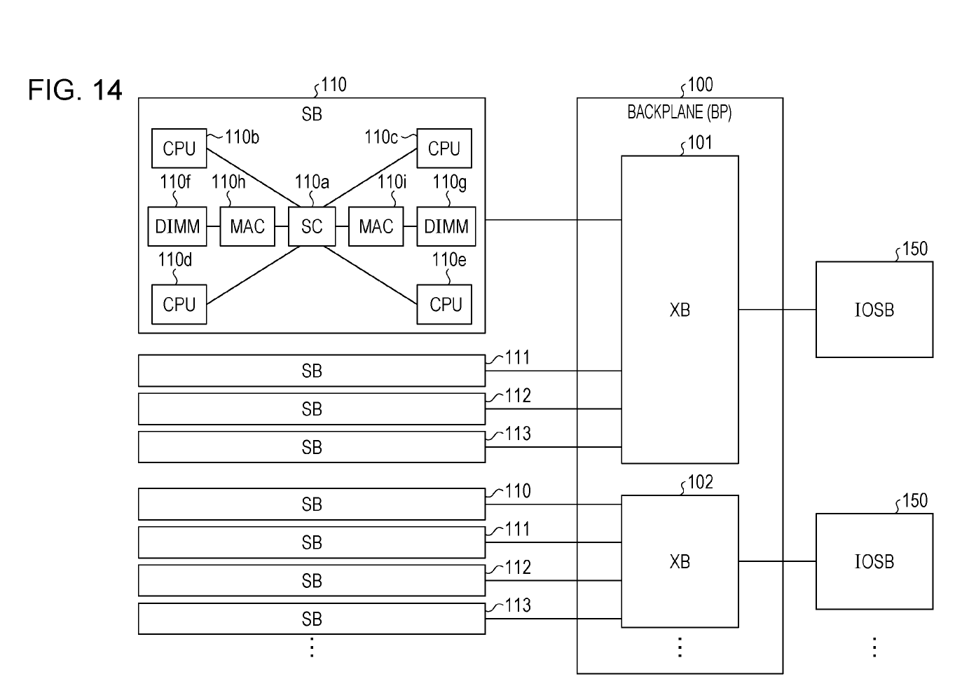

An example of a configuration of a business server disclosed in this embodiment is illustrated in FIG. 14. FIG. 14 is a block diagram for explaining an example of a hardware configuration of a business server. As illustrated in FIG. 14, each business server includes crossbars (XBs) 101 and 102, which are a plurality of switching devices, in the backplane 100, and also includes system boards (SBs) 110 to 113 and an input/output system board (IOSB) 150 for each crossbar. Note that the numbers of crossbars, system boards, and input/output system boards are merely illustrative in the drawing, and are not limited to this.

The backplane 100 is a circuit board for forming a bus through which a plurality of connectors and so forth are mutually connected. The XBs 101 and 102 are switches for dramatically selecting paths of data exchanged among system boards and input/output system boards.

Additionally, the SBs 110, 111, 112, and 113 connected to the XB 101 are electronic circuit boards together forming electronic equipment and include similar configurations, and therefore only the SB 110 will be described here. Note that each SB corresponds to, for example, each partition or server management unit. Additionally, the SB 110 includes a system controller (SC) 110a, four CPUs 110b to 110e, memory access controllers (MACs) 110h and 110i, and dual inline memory modules (DIMMs) 110f and 110g.

The SC 110a controls processing such as data transfer between the CPUs 110b to 110e and the MAC 110h and the MAC 110i with which the SB 110 is equipped, and controls the entire SB 110.

Each of the CPUs 110b to 110e is a processor connected through the SC 110a to another LSI for implementing a recovery control method disclosed in this embodiment. For example, each CPU executes various types of processes performed by an operation unit, a server management unit, and so forth.

The MAC 110h, which is connected between the DIMM 110f and the SC 110a, controls access to the DIMM 110f. The MAC 110i, which is connected between the DIMM 110g and the SC 110a, controls access to the DIMM 110g. The DIMM 110f, which is connected through the SC 110a to another electronic equipment, is a memory module in which a memory is mounted for memory addition and so forth. The DIMM 110g, which is connected through the SC 110a to another electronic equipment, is a memory module as a primary storage device (main memory) in which a memory is mounted for memory addition and so forth.

The IOSB 150 is connected through the XB 101 to each of the SB 110 to SB 113, and is also connected through a small computer system interface (SCSI), a fiber channel (FC), Ethernet (registered trademark) and so forth to an input/output device. The IOSB 150 controls processing, such as data transfer, between the input/output device and the XB 101. Note that electronic equipment, such as CPUs, MACs, and DIMMs, mounted on the SB 110 is merely illustrative, and the types of electronic equipment or the number of pieces of electronic equipment are not limited to those illustrated in the drawing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing device comprising:
a detector configured to, when a second processing function unit monitored over a second management network is recovered by using a first processing function unit that performs a function as an information processing device and that is monitored over a first management network, detect a conflict between first network information used by the second processing function unit in the second management network and second network information used by each processing function unit monitored over the first management network; and
a recovery execution unit configured to resolve the conflict between the first network information and the second network information detected by the detector so as to recover the second processing function unit by using the first processing function unit.

2. The information processing device according to claim 1, wherein, when recovering the second processing function unit by using the first processing function unit during a stop in operation, the recovery execution unit is configured to reset a management address used in the first management network of any of processing function units having conflicting management addresses used in the first management network to a management address that does not result in a conflict, so as to recover the second processing function unit.

3. The information processing device according to claim 1, wherein, when recovering the second processing function unit by using the first processing function unit during operation, the recovery execution unit is configured to set a management address originally set for the first processing function unit serving as a recovery destination, as the management address after recovery, to resolve a conflict, configured to set a business address included in the network information of the second processing function unit to the first processing function unit, and configured to enable setting of the business address within the first processing function unit.

4. The information processing device according to claim 1,
wherein the first processing function unit is a partition included in a first server device; and
wherein the second processing function unit is a partition included in a second server device different from the first server device.

5. A recovery management method executed by an information processing device, comprising:
when recovering a second processing function unit monitored over a second management network by using a first processing function unit that performs a function as an information processing device and that is monitored over a first management network, detecting a conflict between first network information used in the second management network by the second processing function unit and second network information used by each processing function unit monitored over the first management network; and
resolving the detected conflict between the first network information and the second network information so as to recover the second processing function unit by using the first processing function unit.
